(19) United States
(12) Patent Application Publication
(10) Pub. No.: US 2010/0242069 A1
(43) Pub. Date: Sep. 23, 2010

(54) SYSTEM AND METHOD FOR CREATING PERSONALIZED ADVERTISEMENT AND PERSONALIZING PRODUCTS WITH INTERACTIVE GRAPHICAL USER INTERFACE EMBEDDED IN ADVERTISEMENT

(75) Inventors: Jaewoo Jung, Palo Alto, CA (US); John Kim, Portland, OR (US)

Correspondence Address: PATENT OFFICE OF DR. CHUNG S. PARK, P. O. BOX 62312, SUNNYVALE, CA, 94088-2312, US

(73) Assignee: EPSODIC, L.L.C., Palo Alto, CA (US)

(21) Appl. No.: 12/724,310

(22) Filed: Mar. 15, 2010

Related U.S. Application Data
(60) Provisional application No. 61/210,402, filed on Mar. 17, 2009.

(51) Int. Cl. H04N 5/445

(52) U.S. Cl. 725/60

(57) ABSTRACT

Systems, methods, and computer storage media for creating a personalized advertisement. A web development platform prepares an interactive user interface including a personalization area; prepares an advertisement; embeds the user interface in the advertisement; and sends the advertisement with the embedded interactive user interface to a device via a network to thereby enable a user of the device to use the embedded interface for personalization of the personalization area. When the user uploads an image file to be displayed on the personalization area, the platform causes a process to produce a personalized video including the personalization area to thereby create a personalized advertisement and displays the personalized video on the device.

### CROSS-REFERENCE TO RELATED APPLICATION

This application claims priority to U.S. Provisional Patent Application No. 61/210,402, filed Mar. 17, 2009, which is incorporated herein in its entirety.

### BACKGROUND OF THE DISCLOSURE

The present invention generally relates to advertisements, and more particularly, to systems and methods for creating personalized advertisements and personalizing products with an interactive graphical user interface embedded in advertisement.

In recent decades, advancements in computer hardware and software technology allow marketers, advertisement agencies and media companies to produce various types of on-line advertisements. For example, Interactive Advertising Bureau discloses a guideline that lists different sizes of Interactive Marketing Unit (“IAB Ad Unit Guidelines 2009 Update,” Interactive Advertising Bureau, available at http://www.iab.net/ad_unit).

As technology advances, attempts to create effective on-line advertisements continue. One way to effectively engage customers is to provide interactivity in advertisements. However, on-line advertisements of existing systems do not allow customers to interactively create their own personalized advertisements. Thus, there is a need for systems and methods to further enable customers to interact with advertisements by embedding an interactive graphical user interface in on-line advertising programs for creating personalized advertisements and personalizing products with an option to purchase the products.

### SUMMARY OF THE DISCLOSURE

In one aspect of the present invention, a method for creating a personalized advertisement includes the steps of: preparing an interactive user interface including a personalization area; preparing an advertisement; embedding the user interface in the advertisement; sending the advertisement with the embedded interactive user interface to a device via a network to thereby enable the device's user to use the embedded interface for personalization of the personalization area; causing a process to produce a personalized video including the personalization area to thereby create a personalized advertisement; and displaying the personalized video on the device.

In another aspect of the present invention, a computer readable medium carrying one or more sequences of pattern data for creating a personalized advertisement, wherein execution of one or more sequences of pattern data by one or more processors causes the one or more processors to perform the steps of: preparing an interactive user interface including a personalization area; preparing an advertisement; embedding the user interface in the advertisement; sending the advertisement with the embedded interactive user interface to a device via a network to thereby enable a user of the device to use the embedded interface for personalization of the personalization area; producing a personalized video including the personalization area to thereby create a personalized advertisement; and displaying the personalized video on the device.

In still another aspect of the present invention, a computer system for creating a personalized advertisement includes an advertisement generation engine for preparing an interactive user interface including a personalization area, preparing an advertisement, and embedding the user interface in the advertisement. The system also includes a communication mechanism for sending the advertisement with the embedded interactive user interface to a device via a network to thereby enable a user of the device to use the embedded interface for personalization of the personalization area. The advertisement generation engine is adapted to produce a personalized video including the personalization area to thereby create a personalized advertisement and the communication mechanism is adapted to send the personalized video to the device.

### BRIEF DESCRIPTION OF THE DRAWINGS

FIG. 1 shows an exemplary world-wide-web page (or, shortly, page) including an advertisement with embedded interactive graphical user interface (GUI) for creating personal advertisements and personalizing products with option to purchase the products in accordance with one embodiment of the present invention;

FIG. 2 shows an exemplary interactive GUI that might be embedded in the advertisement in FIG. 1;

FIG. 3 shows an exemplary file uploading feature of the interactive GUI in FIG. 2;

FIG. 4 shows an example of data input completed by a user of the interactive GUI in FIG. 2;

FIG. 5 shows an example of sample images of personalized products which are created with the interactive GUI in FIG. 2;

FIG. 6 shows an exemplary acknowledgment message that might be displayed on the page in FIG. 1 upon completion of user interaction with the interactive GUI in FIG. 2;

FIG. 7 shows an exemplary e-mail message that informs the results of user interaction with the interactive GUI in FIG. 2;

FIG. 8 shows a system environment in accordance with another embodiment of the present invention;

FIG. 9 shows a flow chart illustrating exemplary steps that may be carried out to generate a personalized advertisement and personalizing products in accordance with another embodiment of the present invention; and

FIG. 10 shows an embodiment of a computer of a type that might be employed in accordance with an embodiment of the present invention.

### DETAILED DESCRIPTION OF THE PREFERRED EMBODIMENTS

The following detailed description is of the best currently contemplated modes of carrying out the invention. The description is not to be taken in a limiting sense, but is presented merely for the purpose of illustrating the general principles of the invention, since the scope of the invention is best defined by the appended claims.

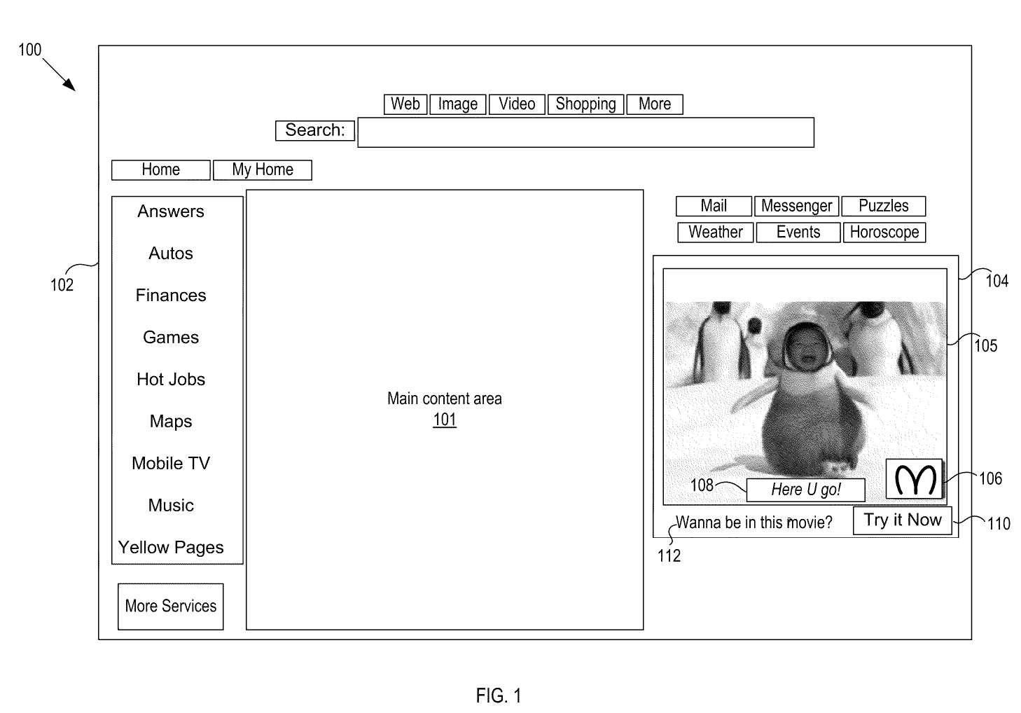

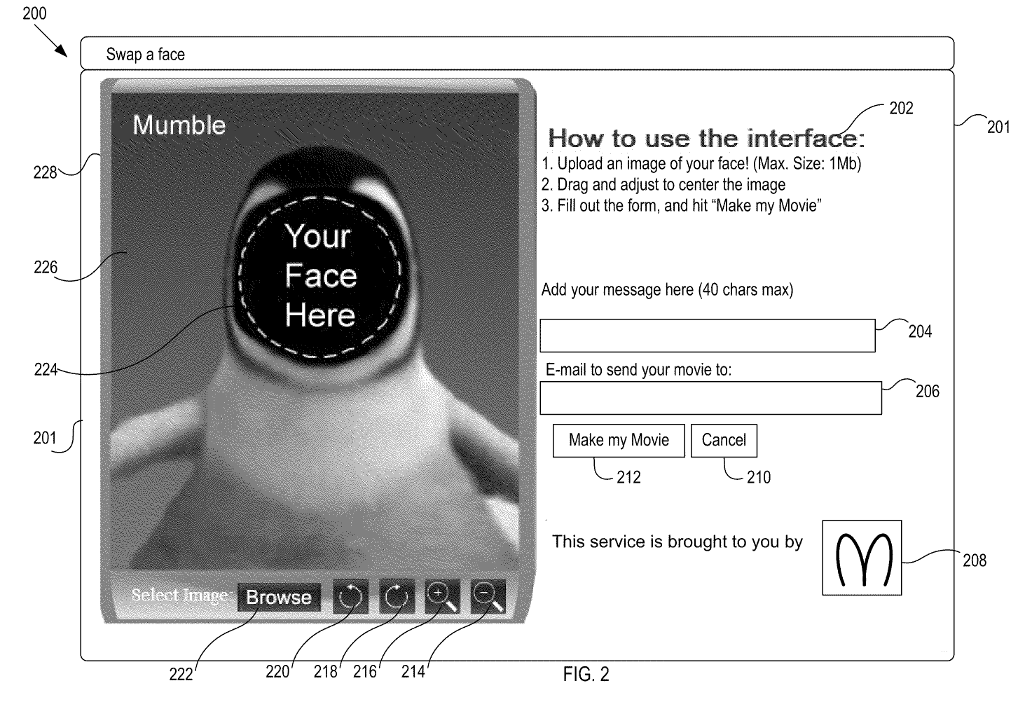

Referring now to FIG. 1, there is shown at 100 an exemplary world-wide-web page (or shortly, page) 102, which displays an embodiment of advertisement 104 with an embedded interactive graphical user interface, GUI, for creating personal advertisements and personalizing products with an option to purchase the products. The embedded interactive graphical user interface is described in conjunction with FIG. 2.

The page 102 refers to any world-wide-web page that may be rendered on any network-enabled interactive devices. Desktop computers, laptop computers, mobile phones, personal media players, personal navigation devices, and digital picture frames that are connected to a network, or have capability to connect to the network, are examples of network-enabled interactive devices. The network may include any suitable connections for communicating electrical signals therethrough, such as WAN, LAN, or the Internet.

The page 102 may include the main content area 101 and user interface component, such as buttons and text fields, that would display additional information and/or open a new page when clicked by the user. It should be apparent to those of ordinary skill in the art that the page may include other suitable user interface components and arrangements thereof without deviating from the spirit and scope of the present teachings. The page 102 is an example of a carrier of the advertisement 104. Other forms of the carrier include an application for network-enabled interactive devices, such as a mobile phone application.

The advertisement 104 may include a main advertisement area 105; an advertisement logo area 106; an advertisement message area 108; a button 110 to initiate user interaction with an embedded interactive GUI; and additional advertisement message area 112. The embedded interactive GUI is described in conjunction with FIGS. 2-4.

The main advertisement area 105 displays an advertisement with at least one personalization area which a user may personalize with the embedded interactive GUI. For example, the advertisement shown in the main advertisement area 105 is a video of a dancing penguin, with the facial area of the penguin as a personalization area. The facial area may be replaced by a user submitted (and preferably adjusted) image through the embedded interactive GUI. In another example, the advertisement shown in the main advertisement area 105 can be a single image with at least one personalization area, or multiple images with at least one personalization area. The multiple images may be displayed as a slide show or as other animation methods and formats, such as animated GIF.

The advertisement logo area 106 contains an advertisement logo. The advertisement message area 108 contains an advertisement message which is shown within the main advertisement area 105. The additional advertisement message area 112 contains an advertisement message which is displayed within the advertisement 104, outside of the main advertisement area 105. For example, the advertisement logo 106 and advertisement messages 108 are ones from a company which sponsors an advertisement campaign through the advertisement 104. Alternatively, the advertisement logo area 106, the advertisement message area 108, and the additional advertisement message area 112 may each contain advertisement logo and messages from different advertisement providers, respectively.

The button 110, when activated by clicking, initiates an interactive session with an embedded interactive GUI. It should be apparent to those of ordinary skill in the art that all or a part of an area contained in the advertisement 104 may be designated to initiate an interactive session with an embedded interactive GUI. For example, an interactive session is initiated when the designated area receives a signal, such as a click on the designated area with a pointing device (a mouse).

FIG. 2 shows an exemplary embedded interactive GUI 200 that is displayed on top of the page 102 when the button 110 is clicked. As depicted, the embedded interactive GUI 200 is contained within an interactive session window 201. The interactive session window 201 may include an interface usage instruction area 202; a personal message area 204; an e-mail submission area 206; a sponsor area 208; a completion button 212; a cancel button 210; and a personalization interface 228. It should be apparent to those of ordinary skill in the art that the interactive session window 291 may contain other suitable information and user interface components, such as buttons.

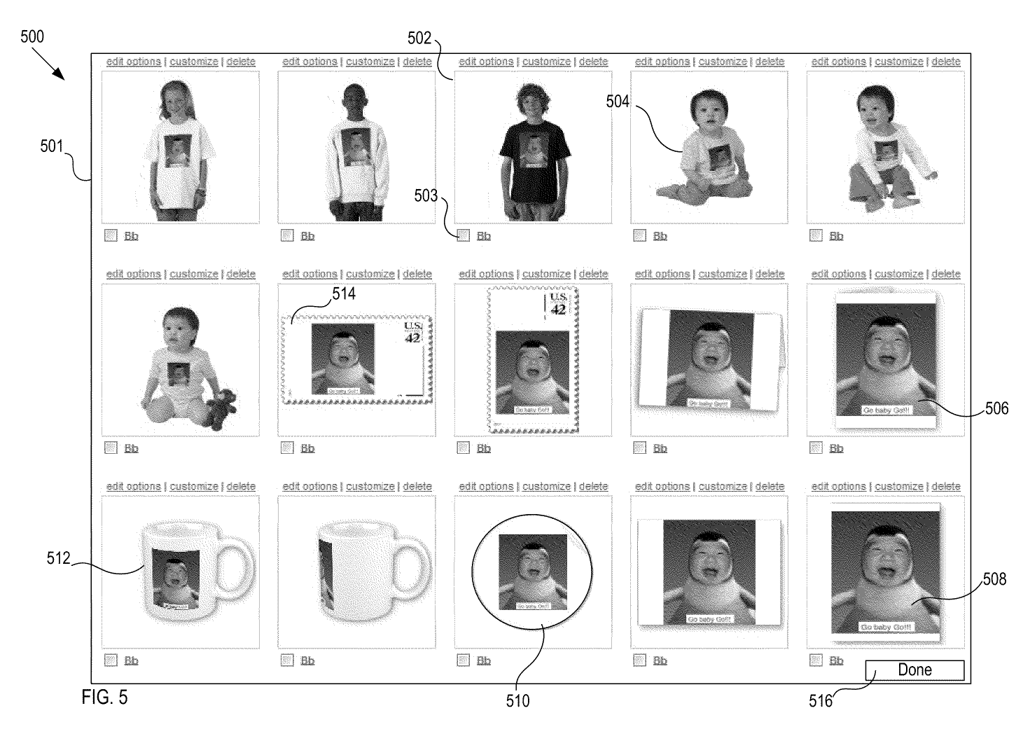

The interface usage instruction area 202 contains an instruction of how to use the embedded interactive GUI 200 in the interactive session window 201, which is in text format in one embodiment. Alternatively, the instruction may be in form of video or animation of images. The personal message area 204 contains a user input area for personal message, which may be included in a personalized advertisement and personalized products. Details of creating a personalized advertisement will be described below with reference to U.S. patent application Ser. No. 12/006,350, entitled “Systems and methods for generating personalized computer animation using game play data,” filed on Dec. 31, 2007, which is herein incorporated by reference in its entirety. Details of personalizing products are described below with reference to FIG. 5.

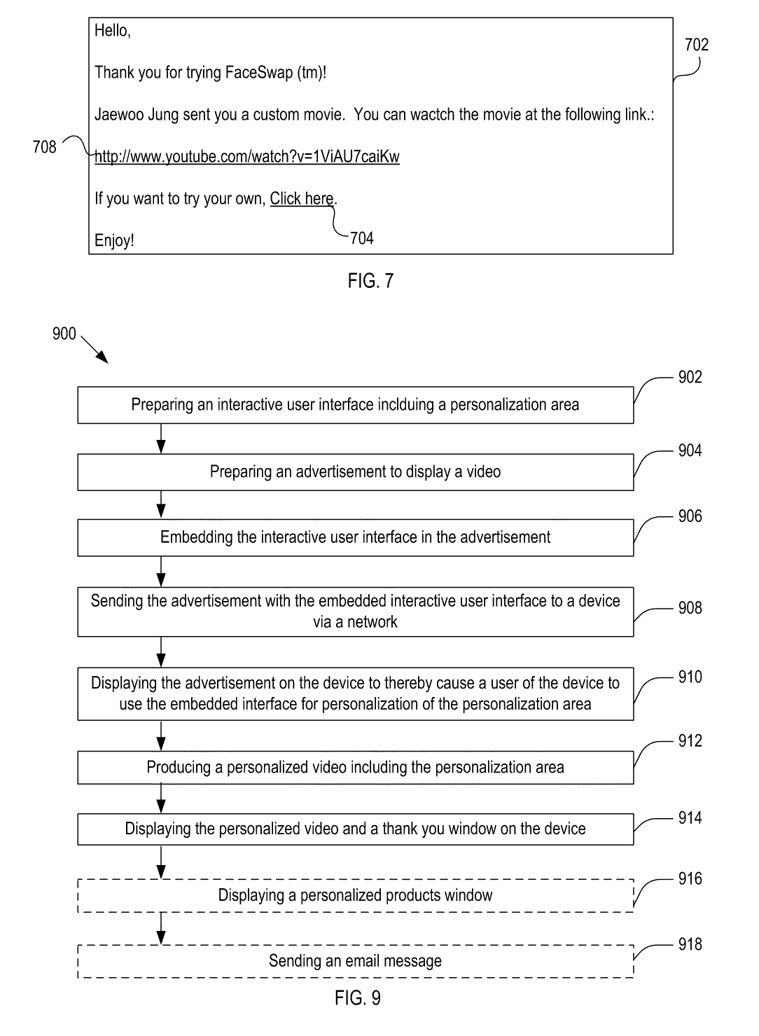

The e-mail submission area 206 contains a user input area for e-mail addresses. The user can submit one or more e-mail addresses to send a message containing results of the user's interaction with the embedded interactive GUI 200. Details of the message are described below with reference to FIG. 7. Alternatively, the e-mail submission area may also include various hyperlinks which perform sharing and posting of the personalized advertisement through the Internet when activated by the user. The sponsor area 208 contains messages from advertisers. For example, text and a logo of a company that sponsored the advertisement 104 are shown in the sponsor area 208. Alternatively, the sponsor area 208 may contain different types of advertisements from advertisers, such as banner advertisements.

The completion button 212, when activated by clicking, initiates creation of the personalized advertisement and its delivery process; initiates creation of sample images of personalized products; sends messages to the e-mail addresses submitted in the e-mail submission area 206; closes the interactive session window 201; and opens a sample personalized products window 501, shown in FIG. 5. The cancel button 210 cancels the interactive session when activated, by closing the interactive session window 201.

The personalization interface 228 is an interface which the user can use to personalize the personalization area of the advertisement shown in the main advertisement area 105. For example, the personalization interface 228 includes a face image plate 226; a face hole 224; a browse button 222; a turn left button 220; a turn right button 218; a zoom in button 216; and a zoom out button 214. The face image plate 226 shows a frontal picture of the dancing penguin, which is shown in the main advertisement area 105. The face hole 224 represents the personalization area of the dancing penguin advertisement. The user can submit an image to fit in the face hole 224 through the browse button 222.

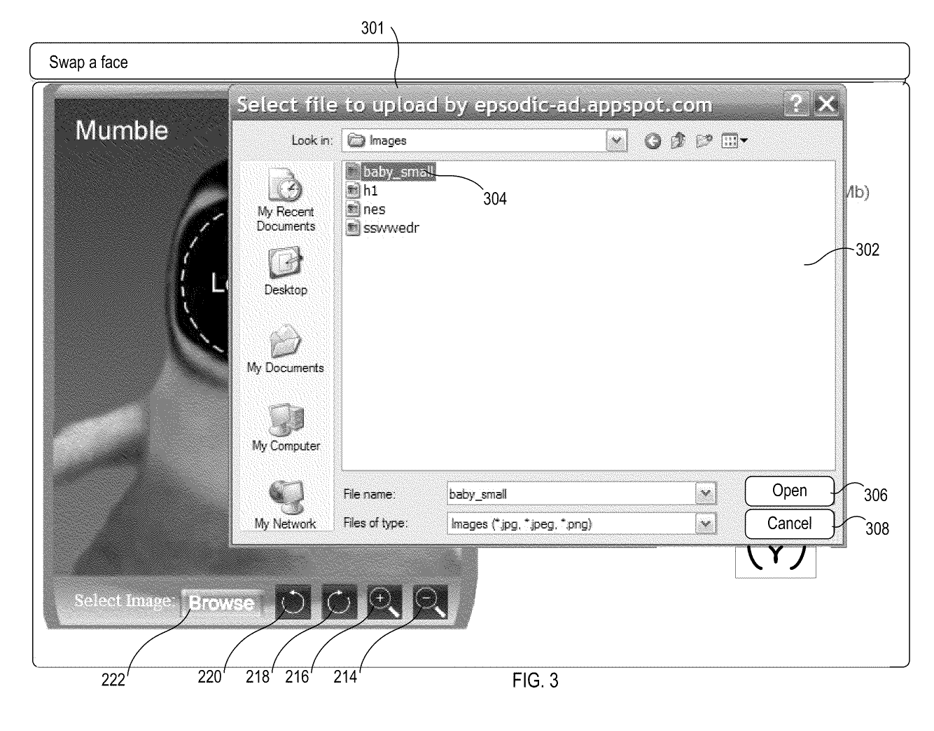

When the browse button is activated by clicking, a file upload window 301 may appear, as shown in FIG. 3. In the file upload window 301, an image file 304 is selected from a file list area 302, and uploaded to the personalization interface 228 when an image open button 306 is clicked. An image open cancel button 308 cancels the image open process and closes the file upload window 301, when activated by clicking.

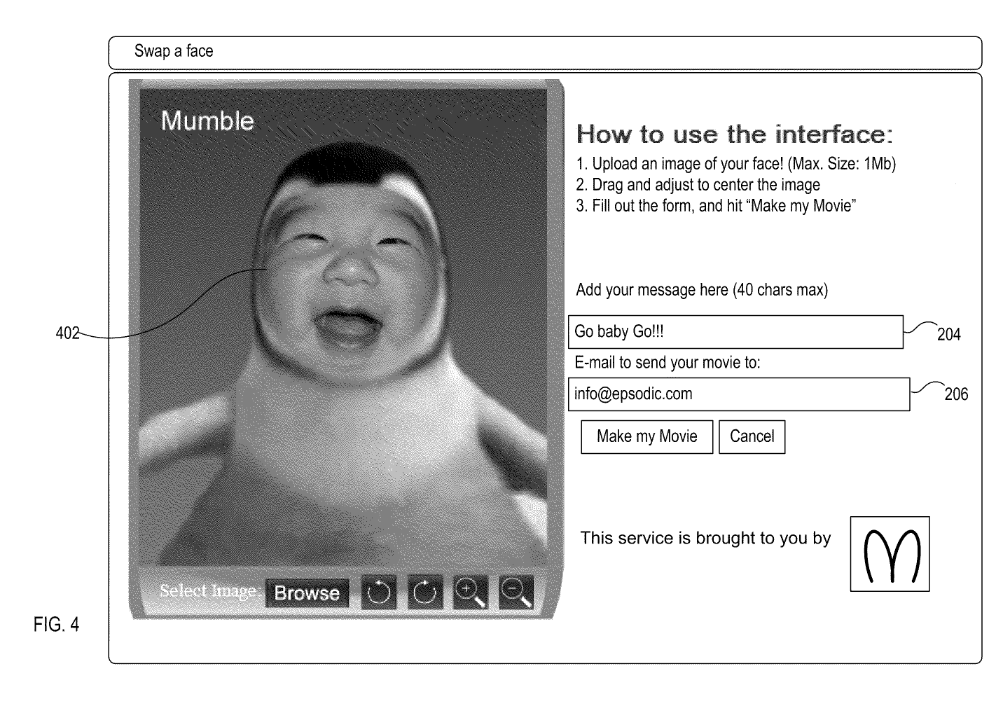

Once an image is uploaded by the user to the personalization interface 228, the image can be adjusted by the user to fit in the face hole 224. To adjust the image, the user can click and move the uploaded image through the face image plate 226 and the face hole 224, and rotate and zoom the image with the turn left button 220, the turn right button 218, the zoom in button 216, and the zoom out button 214, respectively. In FIG. 4, an example of a user adjusted image 402 is shown, along with completed personal message in the personal message area 204 and e-mail address in the e-mail submission area 206.

After the user completes interaction with the embedded interactive GUI 200, the user may click the completion button 212 (shown in FIG. 2). When the completion button 212 is clicked, the following steps are initiated and processed. First, a personalized advertisement is created. The personalized advertisement is created by modifying pre-production items of the advertisement shown in the main advertisement area 105, with the user submitted and adjusted image, such as 402 in FIG. 4 and the personal message submitted in the personal message area 204, then producing a personalized animation in the custom animation platform. As previously mentioned, the detailed description of pre-production items, modification of pre-production items and personalized animation production in the custom animation platform can be found in U.S. patent application Ser. No. 12/006,350, entitled “Systems and methods for generating personalized computer animation using game play data.” The produced personalized animation is the personalized advertisement, featuring the result of the user interaction with the embedded interactive GUI 200. The personalized advertisement may be displayed on the main advertisement area 105 once produced, and also stored in a server for later viewing. Optionally, a hyperlink to view the personalized advertisement may be also generated and stored.

When the advertisement shown in the main advertisement area 105 is a single image with at least one personalization area, or multiple images with at least one personalization area, instead of personalized animation, a personalized image and images are generated in a similar manner described above. Alternatively, to generate a personalized advertisement image or images, modifications such as scaling, rotating and positioning of the user submitted and adjusted image as well as the user submitted message are performed to composite the image and message with pre-fabricated image templates.

The step continues to generate sample images of personalized products. The sample images are generated by placing the user submitted and adjusted image, such as 402 in FIG. 4, and the user message submitted in the personal message area 204, onto previously prepared product image templates. Necessary modification, such as scaling, positioning and rotating of the user's image and message are performed as they are placed on the template. Alternatively, an image, such as a frame, from the personalized advertisement video is used to generate sample images of personalized products. For instance, the user may choose any frame within the personalized advertisement video, or a default frame, such as the ending frame, may be used.

Referring now to FIG. 5, there is shown at 500 an exemplary sample personalized products window 501. The interactive session window 201 closes prior to opening of the sample personalized products window 501. The sample personalized products window 501 includes at least one sample product window 502, purchase selector 503, and a complete button 516. For example, included in the sample personalized product window 501 are shirts with personalized images 502, 504; postal stamps 514; greeting cards 506; mugs 512; a sticker 510; and postcards 508. The user may click the purchase selector 503 of each sample product window, and purchase one or more personalized products by clicking the complete button 516. No purchase is done if the user does not select any of the purchase selectors 503. The production and shipment of the personalized production selected and purchased by the user may be performed by a third party merchant, and therefore description of the processes is not detailed for brevity.

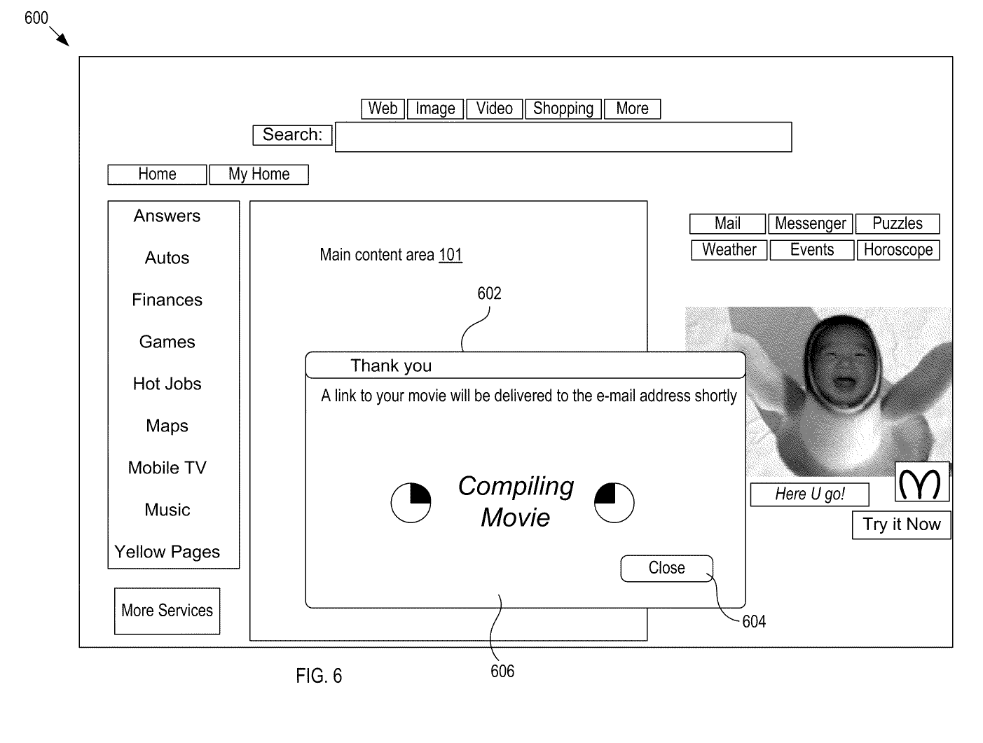

As the complete button 516 is pressed, the sample personalized product window 501 closes, and the steps initiated by clicking of the completion button 212 in FIG. 2 is completed. Subsequently, as shown at 600 in FIG. 6, a thank you window 602 with a session completion message 606 appears on the page 102. The thank you window can be closed by clicking a close button 604.

Referring now to FIG. 7, there is shown an exemplary interaction result e-mail message 702. As depicted, the interaction result e-mail message 702 contains a personalized advertisement play-back hyperlink 708 and a try-your-own hyperlink 704. The interaction result e-mail message 702 is sent to each e-mail address submitted in the e-mail submission area 206. The personalized advertisement playback hyperlink 708 plays the personalized advertisement created by a sender of the original e-mail when clicked. The try-your-own Hyper Link 704 shows the page 102 containing the advertisement 104, the page which the sender of the original e-mail visited, when clicked. Alternatively, the try-your-own hyperlink 704 may open any page 102, displaying the advertisement 104 or other advertisement with a similar embedded interactive GUI 200. It should be apparent to those of ordinary skill that the message 702 may include other suitable contents and hyperlinks without deviating the spirit and scope of the present teachings.

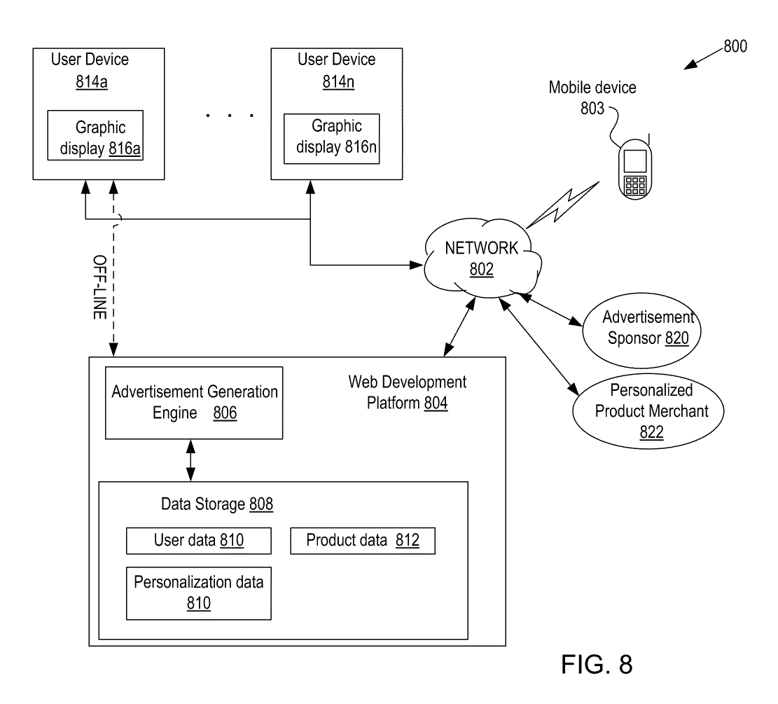

FIG. 8 shows a system environment 800 in accordance with another embodiment of the present invention. As depicted, a web development platform 804 is connected to the user devices 814a-814n and a mobile device 803. The user devices 814a-814n may exchange data with the web development platform 804 via the network 802 or the user may deliver the data via other suitable off-line measures, such as USB storage that contains data. The mobile device 803 may be a portable device having a graphical display panel and a wireless communication port, such as a cell phone, PDA, etc. For brevity, only one mobile device is shown in FIG. 8. However, it should be apparent to those of ordinary skill in the art that the system 800 may include other suitable number of mobile devices.

The web development platform 804 may be a computer that includes one or more computer processers, an advertisement generation engine 806, and data storage 808. The web development platform 804 may provide the user of the platform with tools for designing and developing the web page 102 (shown in FIG. 1). The advertisement generation engine 806, which is a computer program, generates the advertisement 104 included in the web page 102. The data storage 808 may include user data 810 containing user information, such as age, gender, name, or etc. of the user (or customer) who interacts with the web page 102 using the user device 814a-814n and/or the mobile device 804. The data storage 808 may also include personalization data 810 containing the image file 304 uploaded to the personalization interface 228 (more specifically, the personalization area 224) when an image open button 306 is clicked by the customer. The data storage 808 may further include product data 812 containing at least one sample product window 502. When the customer clicks the purchase selector 503 and complete button 516, the advertisement generation engine 806 may store information of the selected purchase product.

The web development platform 804 may be connected via the network 802 to at least one advertisement sponsor 820 which sponsors an advertisement campaign through the advertisement 104, more specifically the advertisement logo 106 and advertisement messages 108. Also, the web development platform 804 may be connected via the network 802 to at least one personalized product merchant 822 which produces and ships the personalized production (shown in FIG. 5) selected and purchased by the user of the user device.

FIG. 9 shows a flow chart 900 illustrating exemplary steps that may be carried out to generate a personalized advertisement and personalizing products in accordance with another embodiment of the present invention. The process begins in a state 902. In the state 902, the user of the web development platform 804 prepares an interactive user interface 200 including the personalization area 224. Then, in a state 904, the user may prepare the advertisement 104 on a web page 102 using the advertisement generation engine 806. Subsequently, the user may embed the interactive user interface 200 in the advertisement 104 in a state 906 and send the advertisement to one or more of the user devices 814a-814n and mobile device 804 in a state 908.

When the user device receives the web page 102 containing the advertisement 104, the web page is displayed so that the customer may use the interactive user interface 200 for personalize the personalization area 224. For example, the customer may upload the image file 304 to the personalization interface 228 (more specifically, the personalization area 224). Next, in a state 912, the advertisement generation engine 806 may receive the information of the uploaded file 304, from a user device, such as 814a, and produce a personalized video, such as a dancing penguin, to thereby create a personalized advertisement. Then, the advertisement generation engine 806 may send the personalized video to the user device and display the video and a thank you window on the advertisement area 105 in a state 914. Optionally, in a state 916, the personalized products window 501 may be displayed when the customer clicks the button 212. As another option, the advertisement generation engine 806 may send email message 702 to the customer in a state 918.

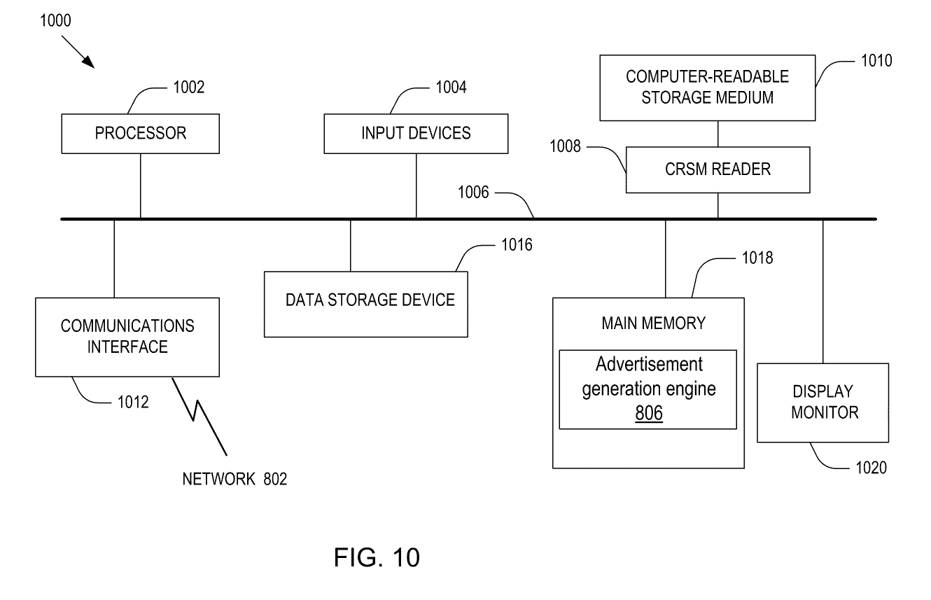

FIG. 10 shows an embodiment of a computer 1000 of a type that might be employed as the web development platform 804 in accordance with the present invention. The computer 1000 may have less or more components to meet the needs of a particular application. As shown in FIG. 10, the computer may include one or more processors 1002 including CPUs. The computer may have one or more buses 1006 coupling its various components. The computer may also include one or more input devices 1004 (e.g., keyboard, mouse, joystick), a computer-readable storage medium (CRSM) 1000, a CRSM reader 1008 (e.g., floppy drive, CD-ROM drive), a communication interface 1012 (e.g., network adapter, modem) for coupling to the network 802, one or more data storage devices 1016 (e.g., hard disk drive, optical drive, FLASH memory), a main memory 1018 (e.g., RAM) containing software embodiments, such as the advertisement generation engine 806, and one or more monitors 1020. Various software may be stored in the computer-readable storage medium 1010 for reading into a data storage device 1016 or main memory 1018.

While the invention has been described in detail with reference to specific embodiments thereof, it will be apparent to those skilled in the art that various changes and modifications can be made, and equivalents employed, without departing from the scope of the appended claims.

What is claimed is:

1. A method for creating a personalized advertisement, comprising:
preparing an interactive user interface including a personalization area;
preparing an advertisement;
embedding the user interface in the advertisement;
sending the advertisement with the embedded interactive user interface to a device via a network to thereby enable a user of the device to use the embedded interface for personalization of the personalization area;
causing a processor to produce a personalized video including the personalization area to thereby create a personalized advertisement; and
displaying the personalized video on the device.

2. A method as recited in claim 1, wherein the step of sending the advertisement includes sending a web page containing the advertisement.

3. A method as recited in claim 1, wherein the personalization data includes a file uploaded by the user of the device.

4. A method as recited in claim 3, wherein the file is an image file and displayed on the personalization area.

5. A method as recited in claim 1, further comprising:
displaying a sample image of a personalized product on the device, wherein the user is able to decide purchase of the personalized product.

6. A method as recited in claim 5, wherein one or more frames of the personalized video is used to create the sample image of the personalized product.

7. A method as recited in claim 1, further comprising, after the step of displaying the personalized video:
sending a message to the user, the message including a hyperlink to the personalized advertisement.

8. A computer readable medium carrying one or more sequences of pattern data for creating a personalized advertisement, wherein execution of one or more sequences of pattern data by one or more processors causes the one or more processors to perform the steps of:
preparing an interactive user interface including a personalization area;
preparing an advertisement;
embedding the user interface in the advertisement;
sending the advertisement with the embedded interactive user interface to a device via a network to thereby enable a user of the device to use the embedded interface for personalization of the personalization area;
producing a personalized video including the personalization area to thereby create a personalized advertisement; and
displaying the personalized video on the device.

9. A computer readable medium as recited in claim 8, wherein the step of sending the advertisement includes sending a web page containing the advertisement.

10. A computer readable medium as recited in claim 8, wherein the personalization data includes a file uploaded by the user of the device.

11. A computer readable medium as recited in claim 10, wherein the file is an image file and displayed on the personalization area.

12. A computer readable medium as recited in claim 8, wherein execution of one or more sequences of pattern data by one or more processors causes the one or more processors to perform the additional steps of:
displaying a sample image of a personalized product on the device, wherein the user is able to decide purchase of the personalized product.

13. A computer readable medium as recited in claim 12, wherein one or more frames of the personalized video is used to create the sample image of the personalized product.

14. A computer readable medium as recited in claim 8, wherein execution of one or more sequences of pattern data by one or more processors causes the one or more processors to perform the additional steps of:
sending a message to the user, the message including a hyperlink to the personalized advertisement.

15. A computer system for creating a personalized advertisement, comprising:
an advertisement generation engine for preparing an interactive user interface including a personalization area, preparing an advertisement, and embedding the user interface in the advertisement; and
a communication mechanism for sending the advertisement with the embedded interactive user interface to a device via a network to thereby enable a user of the device to use the embedded interface for personalization of the personalization area;
wherein the advertisement generation engine is adapted to produce a personalized video including the personalization area to thereby create a personalized advertisement and the communication mechanism is adapted to send the personalized video to the device.

16. A computer system as recited in claim 15, wherein the advertisement generation engine is adapted to generate a sample image of a personalized product.

17. A computer system as recited in claim 16, wherein the communication mechanism is adapted to send the sample image to the device.

18. A computer system as recited in claim 15, wherein the communication mechanism is adapted to send a message to the user, the message including a hyperlink to the personalized advertisement.
